(19) United States
(12) Patent Application Publication
(10) Pub. No.: US 2005/0106064 A1
(43) Pub. Date: May 19, 2005

(54) Microfluidic cell and method for sample handling

(76) Inventors: Thomas Laurell, Lund (SE); Johan Nilsson, Bjarred (SE); Monica Almqvist, Sodra Sandby (SE); Stefan Johnansson, Uppsata (SE); Tobias Lilliehorn, Hagersten (SE)

Correspondence Address: LADAS & PARRY LLP, 224 SOUTH MICHIGAN AVENUE, SUITE 1200, CHICAGO, IL, 60604, US

(21) Appl. No.: 10/508,235

(22) PCT Filed: Mar. 20, 2003
(86) PCT No.: PCT/SE03/00474

(30) Foreign Application Priority Data
Mar. 20, 2002 (SE) 0200860-5

(51) Int. Cl. G01N 21/00; G01N 31/22

(52) U.S. Cl. 422/55; 422/100; 422/58; 436/68

(57) ABSTRACT

The present invention relates to a microfluidic cell and method for sample handling, and more particularly a cell (1) with a one-dimensional or two-dimensional array of ultrasonic transmitters (2) or resonance cavities for trapping biologically activated microbeads and passing fluids carrying samples interacting with the microbeads for detection and analysis. The invention allows for individual loading of the positions in the cell and individual detection steps enabling multistep biological assays to be performed on submicrolitre volumes. The invention also relates to an apparatus and method for blood plasma analysis incorporating such a microfluidic cell.

### FIELD OF THE INVENTION

The present invention relates to a microfluidic cell and method for sample handling, and more particularly a cell with a one-dimensional or two-dimensional array of ultrasonic transmitters or resonance cavities for trapping biologically activated microbeads and passing fluids carrying samples interacting with the microbeads for detection and analysis. The invention allows for individual loading of the positions in the cell and individual detection steps enabling multistep biological assays to be performed on submicrolitre volumes. The invention also relates to an apparatus and method for blood plasma analysis incorporating such a microfluidic cell.

### STATE OF THE ART

Future microfluidic systems for handling of microparticles and beads demand fast individual handling and analysis with minimum of regeneration and inflexible chemistry. The proposed ultrasonic array system solves several problems encountered in prior related techniques like optical tweezers and trapping by means of dielectrophoretic forces. In optical tweezers the trapping force is by orders of magnitude smaller which makes it impossible to trap larger clusters of beads as well as reduces the maximum liquid flow rate. Dielectrophoretic trapping is limited by the dielectric characteristics of the trapped particles and demands electrodes that generate the electric field as well as generate a current through the medium.

In the proposed ultrasonic array system, a chemically or biologically active material, e.g. activated microbeads or living cells, will be trapped in the centre of a flow channel and will be kept away from the walls. Thus there will be no need for coupling chemistry or mechanical means for the immobilisation of the active material. Regeneration of the system will therefore be simple which will lead to a versatile system since the functionality is determined by the chemical functionalisation of the bead surface.

### SUMMARY OF THE INVENTION

According to a first aspect of the invention, there is provided a microfluidic cell having an inlet and an outlet for fluid flow through a channel, characterised by an array of ultrasonic transmitter units arranged at separate positions between the inlet and the outlet; and a control unit for controlling the operation of the array and adapted to activate the transmitter units to create an acoustic radiation pressure at selected transmitter unit positions.

According to a second aspect of the invention, the microfluidic cell may have multiple inlets and outlets for fluid flow through multiple channels, with a first inlet side with inlets for fluid flow in a first direction towards outlets at a first outlet side, a second inlet side with inlets for fluid flow in a second direction towards outlets at a second outlet side, the first direction being essentially orthogonal to the second direction; an array of ultrasonic transmitter units being arranged at separate positions between the inlet and the outlet sides; and a control unit for controlling the operation of the array and adapted to activate the transmitter units to create an acoustic radiation pressure at selected transmitter unit positions.

According to a third aspect of the invention, there is provided a microfluidic cell having inlets and outlets for fluid flow through channels, characterised by a first inlet side with inlets for fluid flow in a first direction towards outlets at a first outlet side, a second inlet side with inlets for fluid flow in a second direction towards outlets at a second outlet side, the first direction being essentially orthogonal to the second direction; a number of separate acoustic radiation pressure trapping positions between the inlet and the outlet sides; and at least one ultrasonic transmitter unit arranged to create an acoustic radiation pressure at at least one trapping position.

According to a fourth aspect of the invention, there is provided an apparatus suitable for plasma analysis incorporating such a microfluidic cell.

According to a fifth aspect of the invention, there is provided a method for sample handling using a microfluidic cell having an inlet and an outlet for fluid flow through a channel, an array of ultrasonic transmitter units arranged at separate positions between the inlet and the outlet; and a control unit for controlling the operation of the array and adapted to activate the transmitter units to create an acoustic radiation pressure at selected transmitter unit positions, characterised by the steps of:
loading the cell with active material;
passing fluid carrying a sample to be analysed through the channel;
letting the sample interact with the active material.

According to a sixth aspect of the invention, there is provided a method for sample handling using a microfluidic cell having multiple inlets and outlets for fluid flow through channels, with a first inlet side with inlets for fluid flow in a first direction towards outlets at a first outlet side, a second inlet side with inlets for fluid flow in a second direction towards outlets at a second outlet side, the first direction being essentially orthogonal to the second direction; an array of ultrasonic transmitter units arranged at separate positions between the inlet and the outlet sides; and a control unit for controlling the operation of the array and adapted to activate the transmitter units to create an acoustic radiation pressure at selected transmitter unit positions, characterised by the steps of:
loading the cell with active material in the first direction;
passing fluid carrying a sample to be analysed through the channels in the second direction;
letting the sample interact with the active material.

According to a seventh aspect of the invention, there is provided a method for sample handling using a microfluidic cell having inlets and outlets for fluid flow through channels, with a first inlet side with inlets for fluid flow in a first direction towards outlets at a first outlet side, a second inlet side with inlets for fluid flow in a second direction towards outlets at a second outlet side, the first direction being essentially orthogonal to the second direction; a number of separate acoustic radiation pressure trapping positions between the inlet and the outlet sides; and at least one ultrasonic transmitter unit arranged to create an acoustic radiation pressure at at least one trapping position, characterised by the steps of:
loading the cell with active material in the first direction;
passing fluid carrying a sample to be analysed through the channels in the second direction;
letting the sample interact with the active material

According to a eighth aspect of the invention, there is provided a method for plasma analysis incorporating such a microfluidic cell.

The invention is defined in the independent claims 1, 2, 12, 25, 28, 29, 42 and 51, while preferred embodiments are set forth in the dependent claims.

### BRIEF DESCRIPTION OF THE DRAWINGS

The invention will be described in detail below with reference to the accompanying drawings, of which:

FIG. 1 is an exploded view in perspective, partly cut-away, of a two-dimensional cell according to the present invention,

FIG. 2 is a cross-section of the cell in FIG. 1,

FIGS. 3A and 3B are schematic illustrations of the loading flow and analytical flow in one embodiment of the method of the invention,

FIGS. 4A and 4B are schematic illustrations from above and in perspective of one design of a resonance cavity in one embodiment of the invention,

FIGS. 5A and 5B are schematic illustrations from above and in perspective of another design of a resonance cavity in one embodiment of the invention,

FIG. 6 is a schematic illustration of a channel grid in one embodiment of the invention, and

FIGS. 7A, 7B and 7C are schematic illustrations of various designs of excitation elements according embodiments of the present invention.

### DETAILED DESCRIPTION OF PREFERRED EMBODIMENTS

This application outlines the development of a new microfluidic platform for miniaturised sample handling in array formats ultimately for 2D (two-dimensional) large-scale parallel analysis of biological samples e.g. screening. A special case is a one-dimensional cell with only one channel and a one-dimensional array of ultrasonic transmitter trapping positions. The use of ultrasonic trapping of biologically activated material e.g. microbeads in a microscaled array format will enable advanced multistep biological assays to be performed on submicrolitre sample volumes. The system can be viewed as a generic platform for performing any microbead based bioassay in an array format. The described ultrasonic based microbead trapping and spatially controlled transport of the beads in the assay area of the microsystem is a key concept which in conjunction with microdomain laminar sheet flow offers a 2D-format for the analysis system. As multiple analytical techniques can be employed for the signal readout e.g. electrochemical simultaneous with optical (fluorescence—CCD-imaging), a wealth of information from the assay may be collected.

The invention is described with microbeads as an example of active material. Generally, the active material may be biologically or chemically activated micro/nanoparticles including beads, cells, spores, and bacteria. The beads may be biologically activated by means of e.g. antibodies or oligonucleotides for selective binding of targeted biomolecules, that is antigens and DNA.

The invention provides a fluid cell fabricated by means of micro/nanotechnology for microparticle manipulation and analysis with all the necessary electronics, sensors etc. Real biomolecules can be handled, detected and separated.

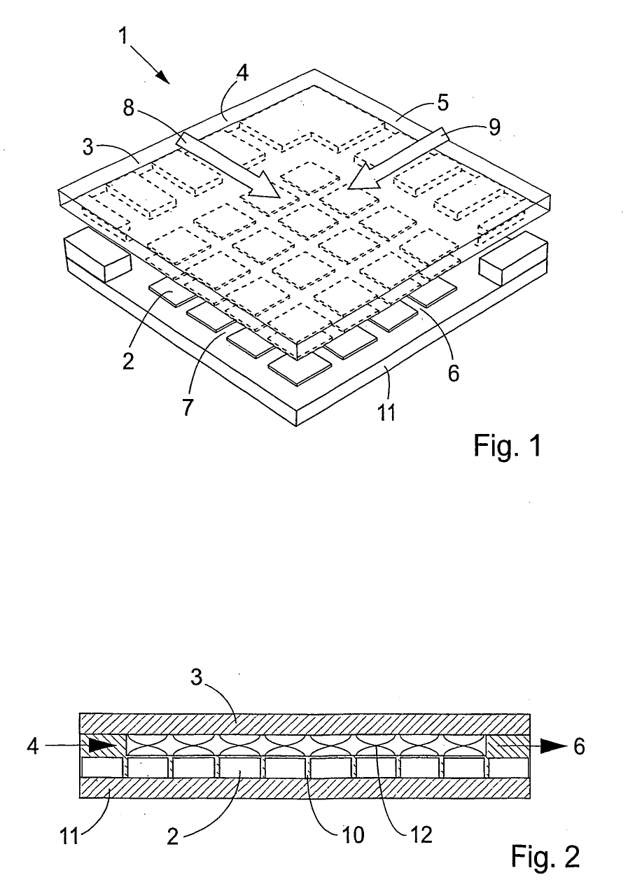

A microscale flow cell 1 according to one embodiment of the invention that uses an actuator or transducer surface divided in several separately addressable “pixels” or ultrasonic trapping elements 2 in an array format is shown in FIGS. 1 and 2. Each element 2 can be independently controlled to trap particles/beads and through co-operation of several elements 2 it will be possible to transport the trapped particles over the array area. Each element 2 can be driven by an AC-signal where the frequency is selected to form a standing wave between the element 2 and the lid 3 of the flow cell 1. An acoustic radiation force array is thus formed where particles/beads can be trapped above each element.

The device could be described as a sealed “square” with several inlets 4, 5 and outlets 6, 7 forming two orthogonal flow paths as shown by the arrows 8, 9. There are no internal walls between the flow paths in the sealed square. The square will have particular positions for detection and analysis and in a subsequent step the particles may be transported to the proper outlet for further analysis, enrichment etc.

The flow cell will have a channel height that allows for a standing wave pattern with one or several velocity anti-nodes, separated by half the wavelength (λ/2) of the ultrasound in the fluid. The standing wave pattern creates an acoustic radiation trapping force either in the velocity anti-nodes or nodes depending on the properties of the media and particle properties. The force is proportional to the frequency. For instance, at an excitation frequency of a few MHz the height of the flow cell will typically be in the millimetre to micrometer range. A piezoelectric PZT transducer array with 250 μm elements arranged in a 10 by 10 array would typically occupy an area of 3 mm by 3 mm. The system volume would thus typically occupy 10 nL/bead coordinate. Higher ultrasound frequencies may be superimposed for sensing purposes.

The channel height allows for laminar flows through the cell during operation with normal flow velocities. Thus, there is no mixing of the different liquids except for a very limited diffusion region along the borderline between each parallel flow line. However, it is possible to achieve non-laminar flows by increasing the flow rate in selected channels. This can be exploited to mix channels in a desired way.

The actuator surface is preferably a micromachined piezoelectric multilayer structure consisting of sub-millimetre-sized (e.g. 250 micrometer) pixels with integrated impedance matching and backing layers/structures. The are several reasons for using a multilayer structure instead of a piezoelectric plate, e.g. it is easier to match electric and acoustic impedance, the drive voltages are reduced and it is easier to improve heat conduction from the transducer. Still for less demanding devices more conventional diced piezoelectric plates can be used as transducers. Micromachining of the actuator structure allows for particular solutions to impedance matching that is important for actuation as well as sensing functions. By introduction of void volumes in the actuator structure, the acoustic impedance is better matched with aqueous fluids.

To trap the beads the acoustic intensity has to be focused spatially and several techniques, such as focussing surfaces, mainly on the underside of the lid, and phase shifting between pixels, will be provided. The heating caused by inevitable losses in the material should be minimised and one embodiment of the invention will use integrated cooling channels (not shown). In general the heat conduction is improved by allowing heat transport in the electrical vias, electrodes and pattern.

The actuator array may be fabricated in several actuator materials/devices, e.g. piezoelectric, electrostrictive, relaxor, magnetostrictive, polymer, ceramics and silicon allowing for three-dimensional microstructuring of the active material. To prepare for an easy and individual contacting of the pixels, a vertical electrical via-patterning can be made. The piezoelectric elements may be embedded in a silicon or polymer substrate 11 with an air-gap, low acoustic impedance or dampening material 10 surrounding each piezoelectric element. A convenient way of building the transducer array is to use a flexible printed circuit board as the matching layer between the fluid cell and the array elements. The circuit board may comprise additional polymer films laminated on top of the transducer surface isolating the substrate 11 from the liquid and acting as a further acoustic impedance match. The thickness is well controlled and the electrical pattern can be made on the side facing the transducer array. All contacts to the transducer units of the transducer array may be arranged on the top side of the transducer units. Alternatively, one pole of each transducer unit is one the top and the other at the bottom in contact with the substrate. This simplifies the assembling and gives more freedom regarding heat transport and electrical connections.

The liquid cell will typically have a micromachined glass or polymer lid 3 sealed to the active surface. The transparent lid will at the same time be a reflector for the ultrasonic semi-standing waves and a window for optical or a carrier for micro-electrodes for electrochemical detection. The lid may be provided with focussing surfaces on the underside e.g. shallow cup-shaped cavities over each ultrasonic transmitter position.

In an alternative embodiment, the lid comprises an actuator array of transducer units so that the microfiuidic cell is formed of pairs of opposing transducer units. This embodiment is capable of generating particularly strong acoustic trapping forces.

The lid may comprise transparent windows at desired positions to which material is moved for detection by controlling the flows and/or the operation of the transducer units. It is also possible to use the cell without any detection step in case a well-defined process is run. In this case, samples typically interact with active material at predetermined positions, and the material at these positions is collected and released from the cell for further processing outside the cell. Typical applications are purification processes.

The primary types of sensors considered for analysis inside the square are based on optical and electrochemical techniques while the acoustic detection is mainly intended for detection of the presence of bead or not during the loading of the cell. The acoustic manipulation as well as the ultrasonic detection will however in some cases give additional information. The transport properties during manipulation will be one possible parameter for separation and combining this with the sensor information makes it possible to make separations in several different ways.

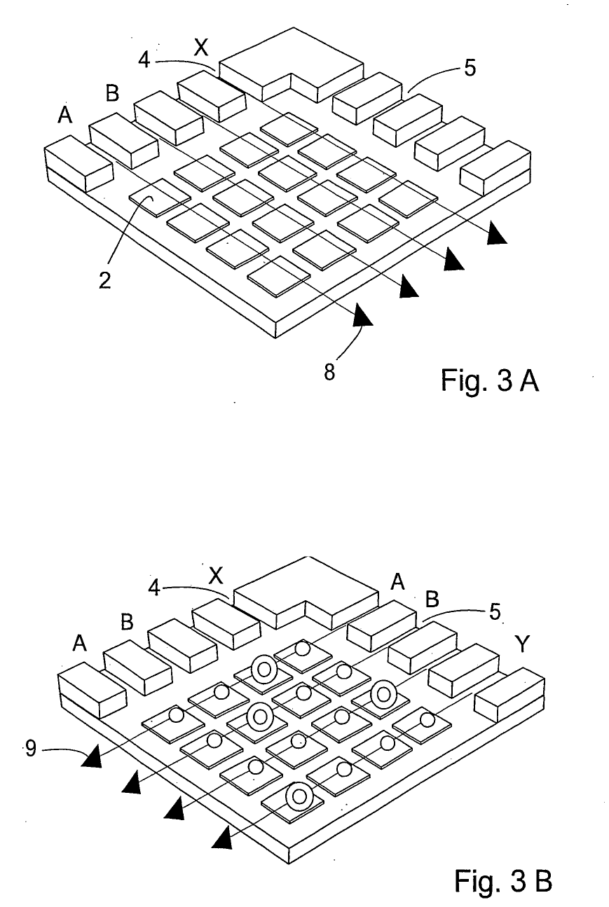

An example of the cell operation is illustrated in FIGS. 3A and 3B. Prior to the analysis step the cell is loaded by supplying different bead flows 8 to the channels through the inlets 4 (A, B, . . . , X) to the left. By switching on the ultrasound the beads are trapped in positions 2 set by the transducer array. The downstream positions are loaded first. It is possible to arrange the same type of beads throughout the whole cell, or different types in different channels, or even different types at each individual position depending on the particular application.

The analytical flows 9 carrying samples to be analysed is then supplied orthogonally to the bead flow through the inlets 5 (A, B, . . . , Y) to the right. Each laminar sample flow line passes each orthogonal flow line A-X, with different or the same types of beads, as the case may be. The cell may then be subjected to a detection procedure. For instance, the cell is illuminated and the fluorescence signal is detected by e.g. a CCD-camera or a fluorescence microscope. Since the microscale flow is always laminar there is no mixing of the different liquids except for a very limited diffusion region along the borderline between the each sample line 9.

After the detection, identified samples may be transported between positions in the cell. This is achieved by operating the ultrasonic transmitters, switching them on and off and/or using phase-shifting between positions. For instance, lowering the intensity at one position and increasing the intensity at another neighbouring position will move the material from the first to the latter position. The effect exists in the absence of any flow and even counter to the flow. Instead of lowering the intensity, the frequency may be changed to remove the resonance condition which has the effect of removing the trapping force at that position. Also, flows may be supplied through selected inlets 4 and 5. Samples may be collected in a common flow line, and the collected samples may then be released from the cell by switching off the ultrasonic transmitters in the desired flow line for further analysis or processing outside the cell.

The transportation of beads by sequentially switching the acoustic field along the transducer array has to be well controlled. The electronics control of the individual pixels should be as simple as possible without risks for bead loss. To increase the manipulation control the sensing function of the pixels can be used to verify a successful movement. Transportation over longer distances than between two pixels can be considered as repetitions of a one-pixel step.

A simplified embodiment of the invention comprises a cell with only one channel, i.e. a one-dimensional cell. A cross-section will be as shown in FIG. 2. In this case the loading flow and the analytical flow are not orthogonal to each other but flows along one and the same channel. However, by loading the cell with different types of active material, starting with the farthest down-stream position, it is possible to obtain a diversity, in that the analytical flow is subjected to different bioactive interactions when flowing through the channel.

It is also possible to obtain a separation orthogonal to the active transducer surface plane, i.e. in the height direction. By selecting the ultrasonic frequency such that the channel height corresponds to more than one velocity anti-node several clusters of beads are trapped above each ultrasonic transmitter. The laminar flow of the liquid will also allow for a three dimensional manipulation and analysis. The inlets and outlets are provided with separate channels enabling independent laminar flows at different heights of the cell in addition to the orthogonal flow directions. Thus, samples at different height positions can be moved by liquid flow at different heights or groups of samples trapped above each other can be moved at the same time. For instance, a channel height of 300 μm can accommodate six channels each 50 μm high. Frequency modulations and phase modulations changes the acoustic radiation pressure at the different nodes and the trapping sites above each array pixel can therefore be controlled more or less individually.

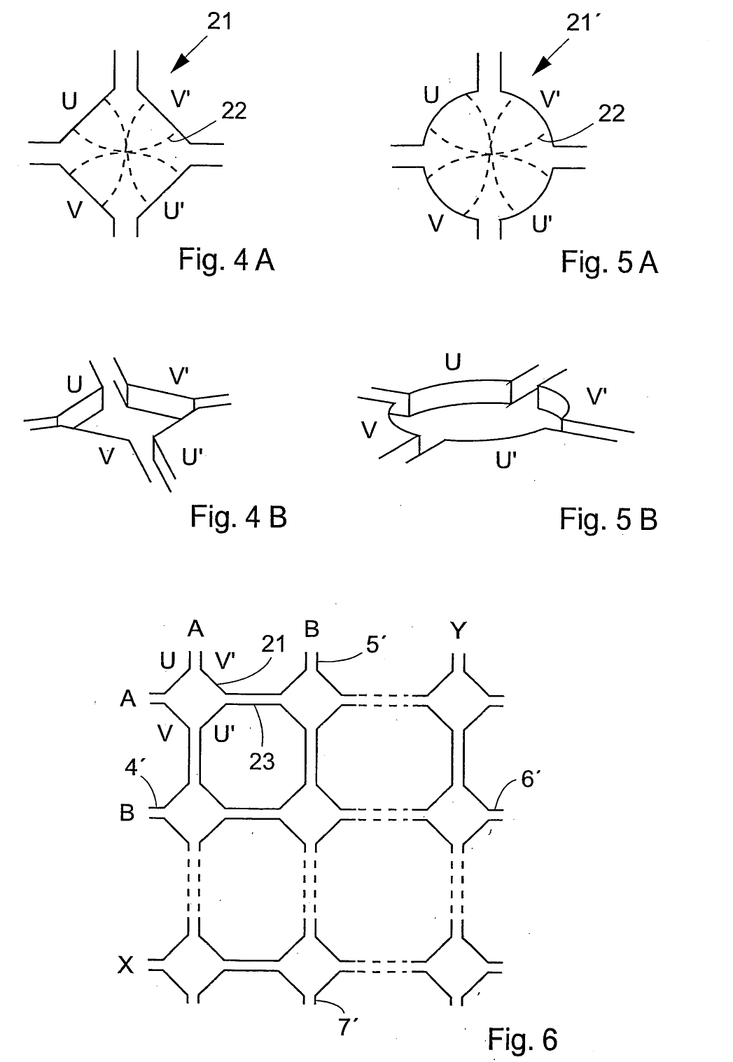

Further embodiments of the invention is shown in FIGS. 4AB to 7A-C. The main difference to the previous embodiments is that the interior of the cell is not open but comprises a channel grid structure with walls between channels. Each crossing point in the channel grid forms a resonance cavity. An acoustic radiation pressure is produced by means of acoustic resonance in the horizontal direction in the resonance cavity between the walls at the crossing points between the channels. The resonance cavities will have a channel width that allows for a standing wave pattern with one or several velocity anti-nodes, separated by half the wavelength (λ/2) of the ultrasound in the fluid. Also the height of the channels may be adapted to fulfil the resonance condition so that an increased trapping force acting on the particles is obtained.

Two designs of resonance cavities 21, 21′ are shown in FIGS. 4A, 4B and 5A, 5B, respectively. The cavity is defined by four vertical opposing walls between which standing waves 22 are produced in two or more directions U-U′ and V-V′ as is shown by the dotted lines. Two crossing flows are generally passing through the cavity. In FIG. 4AB the walls are straight giving rise to a planar standing wave in two directions. In FIG. 5AB the walls are circular segments giving rise to circular symmetric standing waves.

In alternative embodiments, a cavity may be provided with a greater number of inlets and outlets than shown in the figures. For example, three flows may cross in a cavity. Also, in some applications the number of inlets to the cavity need not be equal with the number of outlets. Furthermore, the angle between flows need not orthogonal in a geometrical sense, but any practical angle may be used.

As is shown in FIG. 6, a number of resonance cavities 21 (straight or circular symmetric) may be combined with communicating connection channels 23 into a grid in which each crossing defines an analysis position where e.g. biospecific microparticles (microbeads) are trapped. In analogy with the previous embodiments, the cell thus comprises first and second inlet sides 4′, 5′ and first and second outlet sides 6′, 7′. The first inlets and outlets are associated with rows A-X, and the second inlets and outlets are associated with rows A-Y. For example, each row A-X of the grid may define a particle type and by letting each orthogonal channel A-Y define a sample flow (e.g. a blood plasma sample) a multi-analysis chip is obtained.

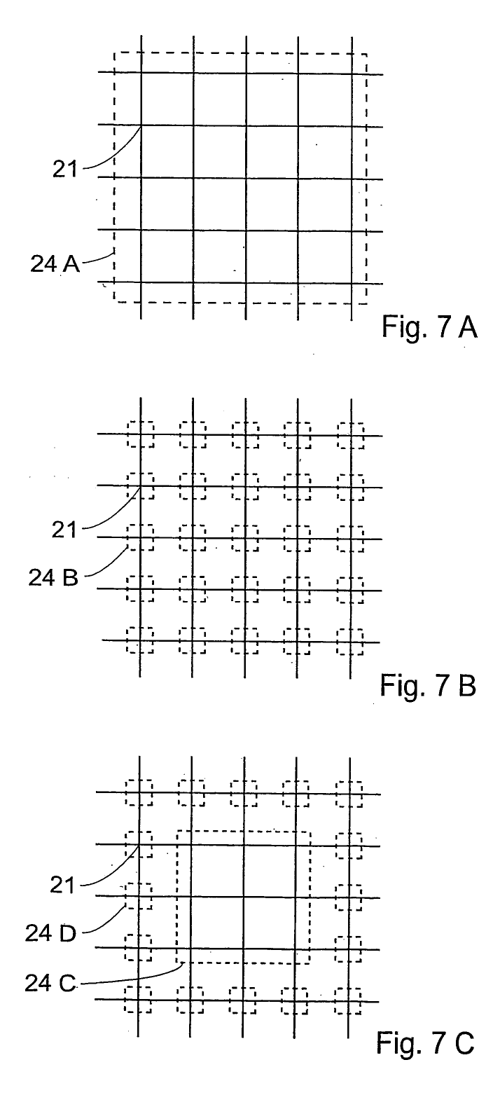

The standing waves are produced by exciting the cell by means of one or more excitation elements or transducers of the types discussed above. The shape and design may be varied for instance as is shown in FIGS. 7A-C described below.

In FIG. 7A one excitation element 24A covers the whole channel grid and excites all positions at the same time. In FIG. 7B there is one excitation element 24B for each position 21 (resonance cavity). By designing the chip in a suitable way the excitation of one individual cavity will not interfere with neighbouring cavities. Thus, each position can be excited individually. FIG. 7C shows a combination of an element 24C exciting several positions with individual element 24D exciting individual positions. It is also possible to use an excitation element that only covers part of the grid (not shown) without exciting the remainder of the positions.

One contemplated application of the microfluidic cell according to the invention is analysis of blood plasma. The microfluidic cell is incorporated in an apparatus comprising a blood plasma separator for receiving a blood sample and separating the plasma for analysis. A suitable blood plasma separator is described in PCT/SE02/00428 (not yet published). A microprocessor-based control unit controls the operation of the transducer array and various pumps supplying flows through the cell. The apparatus may be designed as a portable bedside device. The microfluidic cell is preferably exchangeable and provided as a disposable product.

A number of vials or a cassette containing active material especially prepared for the desired, often standardised, analysis is connected to the inlets 4 for loading the cell. The microfluidic cell is connected to receive the separated plasma at the inlets 5 for the analytical flow. When the cell is started an automatic loading procedure is performed bringing active material to predetermined positions in the cell by means of pumps and controlling the transducer array to switch on trapping forces in a programmed time sequence. The loading step will only take a few seconds or less. In the meantime, a blood sample is collected from a patient and the plasma is separated. A blood sample volume of 0.5 ml or less will be sufficient and can be collected together with a sample for other conventional tests. Then the analytical flow containing the plasma is brought through the cell interacting with the active material in dependence of the contents of the plasma. The interaction step will only take a few seconds or less. The detection procedure is then started performing an automatic scanning of the different positions and e.g. looking for presence or absence of reactions. The apparatus may be connected to a data system for storing and/or printing the results of the analysis.

The scope of the invention is only limited by the claims below.

1-51. (canceled)

52. A microfluidic cell having an inlet and an outlet for fluid flow through a channel, comprising an array of ultrasonic transmitter units arranged at separate positions between the inlet and the outlet, each ultrasonic transmitter unit capable of being independently controlled to create an acoustic ultrasonic radiation pressure; and a control unit for controlling the operation of the array and adapted to activate selected transmitter units to create an acoustic radiation pressure at selected transmitter unit positions; and in that the channel height is of the same order as the ultrasonic wavelength of the fluid.

53. A microfluidic cell according to claim 52, wherein the ultrasonic transmitter units are piezoelectric elements.

54. A microfluidic cell according to claim 53, wherein the piezoelectric elements are embedded in a silicon or polymer substrate.

55. A microfluidic cell according to claim 52, wherein the ultrasonic transmitter units are polymer actuators.

56. A microfluidic cell having inlets and outlets for fluid flow through channels, comprising a first inlet side with inlets for fluid flow in a first direction towards outlets at a first outlet side, a second inlet side with inlets for fluid flow in a second direction towards outlets at a second outlet side, the first direction being essentially orthogonal to the second direction; an array of ultrasonic transmitter units arranged at separate positions between the inlet and the outlet sides, each ultrasonic transmitter unit capable of being independently controlled to create an acoustic ultrasonic radiation pressure; and a control unit for controlling the operation of the array and adapted to activate selected transmitter units to create an acoustic radiation pressure at selected transmitter unit positions; and in that the channel height is of the same order as the ultrasonic wavelength of the fluid.

57. A microfluidic cell according to claim 56, wherein the ultrasonic transmitter units are piezoelectric elements.

58. A microfluidic cell according to claim 57, wherein the piezoelectric elements are embedded in a silicon or polymer substrate.

59. A microfluidic cell according to claim 56, wherein the ultrasonic transmitter units are polymer actuators.

60. A microfluidic cell according to claim 52, wherein the cell comprises a transparent lid.

61. A microfluidic cell according to claim 60, wherein the lid is made of glass or polymer.

62. A microfluidic cell according to claim 60, wherein the lid is provided with sound reflecting surfaces arranged at the transmitter unit positions.

63. A microfluidic cell according to claim 52, wherein the cell comprises a lid with an actuator array of transducer units.

64. A microfluidic cell according to claim 56, wherein the cell comprises a lid with an actuator array of transducer units.

65. A microfluidic cell according to claim 63, wherein the lid comprises transparent windows.

66. A microfluidic cell according to claim 64, wherein the lid comprises transparent windows.

67. A microfluidic cell according to claim 63, wherein the lid is provided with sound reflecting surfaces arranged at the transmitter unit positions.

68. A microfluidic cell according to claim 52, wherein the control unit is adapted to activate the transmitter units to create an acoustic radiation pressure capable of moving material between selected transmitter unit positions.

69. A microfluidic cell according to claim 56, wherein the control unit is adapted to activate the transmitter units to create an acoustic radiation pressure capable of moving material between selected transmitter unit positions.

70. A microfluidic cell having inlets and outlets for fluid flow through channels, comprising a first inlet side with inlets for fluid flow in a first direction towards outlets at a first outlet side, a second inlet side with inlets for fluid flow in a second direction towards outlets at a second outlet side, the first direction crossing the second direction; a number of separate acoustic radiation pressure trapping positions between the inlet and outlet sides; and at least one ultrasonic transmitter unit arranged to create an acoustic radiation pressure at at least one trapping position; and in that the channel height is of the same order as the ultrasonic wavelength of the fluid.

71. A microfluidic cell according to claim 70, wherein the cell comprises a channel grid structure with walls between channels, and each crossing point in the channel grid forms a resonance cavity.

72. A microfluidic cell according to claim 71, wherein an acoustic radiation pressure is produced by means of acoustic resonance in the horizontal direction in the resonance cavity.

73. A microfluidic cell according to claim 72, wherein the resonance cavity is defined by straight vertical opposing walls between which standing waves may be produced.

74. A microfluidic cell according to claim 72, wherein the resonance cavity is defined by circular segments.

75. A microfluidic cell according to claim 70, further comprising one excitation element arranged to cover the whole channel grid and excite all trapping positions at the same time.

76. A microfluidic cell according to claim 75, wherein the excitation elements are piezoelectric elements or polymer actuators.

77. A microfluidic cell according to claim 70, further comprising one excitation element arranged to cover part of the channel grid.

78. A microfluidic cell according to claim 77, wherein the excitation elements are piezoelectric elements or polymer actuators.

79. A microfluidic cell according to claim 70, further comprising one excitation element for each trapping position.

80. A microfluidic cell according to claim 79, wherein the excitation elements are piezoelectric elements or polymer actuators.

81. A microfluidic cell according to claim 70, further comprising a combination of an excitation element exciting several trapping positions with individual excitation elements exciting individual trapping positions.

82. A microfluidic cell according to claim 81, wherein the excitation elements are piezoelectric elements or polymer actuators.

83. A microfluidic cell according to claim 52, wherein the channel height is selected to produce a standing wave pattern.

84. A microfluidic cell according to claim 56, wherein the channel height is selected to produce a standing wave pattern.

85. A microfluidic cell according to claim 70, wherein the channel height is selected to produce a standing wave pattern.

86. A microfluidic cell according to claim 52, wherein the ultrasonic frequency is in the MHz range.

87. A microfluidic cell according to claim 56, wherein the ultrasonic frequency is in the MHz range.

88. A microfluidic cell according to claim 70, wherein the ultrasonic frequency is in the MHz range.

89. A microfluidic cell according to claim 52, wherein the inlets and outlets are provided with separate channels enabling independent laminar flows at different heights of the cell.

90. A microfluidic cell according to claim 56, wherein the inlets and outlets are provided with separate channels enabling independent laminar flows at different heights of the cell.

91. A microfluidic cell according to claim 70, wherein the inlets and outlets are provided with separate channels enabling independent laminar flows at different heights of the cell.

92. An apparatus suitable for plasma analysis comprising a microfluidic cell according to claim 52.

93. An apparatus suitable for plasma analysis comprising a microfluidic cell according to claim 70.

94. An apparatus according to claim 92, further comprising a blood plasma separator for receiving a blood sample and separating the plasma for analysis; a microprocessor-based control unit for controlling the operation of the transducer array and various pumps supplying flows through the cell.

95. An apparatus according to claim 94, further comprising a container containing active material connected to the inlets for loading the cell.

96. An apparatus according to claim 93, further comprising a blood plasma separator for receiving a blood sample and separating the plasma for analysis; a microprocessor-based control unit for controlling the operation of the transducer array and various pumps supplying flows through the cell.

97. An apparatus according to claim 96, further comprising a container containing active material connected to the inlets for loading the cell.

98. A method for sample handling using a microfluidic cell having an inlet and an outlet for fluid flow through a channel, an array of ultrasonic transmitter units arranged at separate positions between the inlet and the outlet; and a control unit for controlling the operation of the array and adapted to activate the transmitter units to create an acoustic radiation pressure at selected transmitter unit positions, comprising the steps of:
loading the cell with active material;
passing fluid carrying a sample to be analyzed through the channel;
letting the sample interact with the active material.

99. A method according to claim 98, wherein the loading step comprises trapping the active materials at selected transmitter unit positions by means of the acoustic radiation pressure.

100. A method according to claim 99, wherein active material of different types are trapped at different selected transmitter unit positions.

101. A method according to claim 99, wherein the trapped active material is released together with the sample for further processing.

102. A method for sample handling a microfluidic cell having inlets and outlets for fluid flow through channels, with a first inlet side with inlets for fluid flow in a first direction towards outlets at a first outlet side, a second inlet side with inlets for fluid flow in a second direction towards outlets at a second outlet side, the first direction being essentially orthogonal to the second direction; an array of ultrasonic transmitter units arranged at separate positions between the inlet and the outlet sides; and a control unit for controlling the operation of the array and adapted to activate the transmitter units to create an acoustic radiation pressure at selected transmitter unit positions, comprising the steps of:
loading the cell with active material in the first direction;
passing fluid carrying a sample to be analyzed through the channels in the second direction;
letting the sample interact with the active material.

103. A method according to claim 102, wherein the loading step comprises trapping the active materials at selected transmitter unit positions by means of the acoustic radiation pressure.

104. A method according to claim 103, wherein active material of different types are trapped at different selected transmitter unit positions.

105. A method according to claim 102, wherein the loading step comprises passing flows with active material of different types through different channels in the first direction.

106. A method according to claim 105, wherein the step of passing fluids further comprises carrying different samples through different channels in the second direction.

107. A method according to claim 102, wherein the trapped active material is released together with the sample for further processing.

108. A method according to claim 102, wherein the trapped active material in a channel in the second direction is released together with the sample for further processing.

109. A method according to claim 102, wherein active material together with sample are moved between selected transmitter unit positions.

110. A method according to claim 109, wherein samples are moved by varying the intensities of the transmitters close to the sample position.

111. A method according to claim 110, wherein active material together with samples are moved to be collected in a common channel, and the trapped active material in the channel is released together with the samples for further analysis or processing.

112. A method according to claim 98, wherein the cell is loaded with active material in the form of bioactive microbeads.

113. A method according to claim 102, wherein the cell is loaded with active material in the form of bioactive microbeads.

114. A method according to claim 98, wherein the cell is subjected to a detection procedure.

115. A method according to claim 102, wherein the cell is subjected to a detection procedure.

116. A method according to claim 114, wherein the detection procedure comprises scanning the transmitter unit positions by means of a CCD camera or a fluorescence microscope.

117. A method according to claim 115, wherein the detection procedure comprises scanning the transmitter unit positions by means of a CCD camera or a fluorescence microscope.

118. A method for sample handling using a microfluidic cell having inlets and outlets for fluid flow through channels, with a first inlet side with inlets for fluid flow in a first direction towards outlets at a first outlet side, a second inlet side with inlets for fluid flow in a second direction towards outlets at a second outlet side, the first direction crossing the second direction; a number of separate acoustic radiation pressure trapping positions between the inlet and the outlet sides; and at least one ultrasonic transmitter unit arranged to create an acoustic radiation pressure at at least one trapping position comprising the steps of:
loading the cell with active materials in the first direction;
passing fluid carrying a sample to be analyzed through the channels in the second direction;
letting the sample interact with the active material.

119. A method according to claim 118, wherein active material of different types are trapped at different selected trapping positions.

120. A method according to claim 118, wherein the loading step comprises passing flows with active material of different types through different channels in the first direction.

121. method according to claim 120, wherein the step of passing fluids further comprises carrying different samples through different channels in the second direction.

122. A method according to claim 119, wherein the trapped active material is released together with the sample for further processing.

123. A method according to claim 119, wherein the trapped active material in a channel in the second direction is released together with the sample for further processing.

124. A method according to claim 118, wherein the cell is loaded with active material in the form of bioactive microbeads.

125. A method according to claim 118, wherein the cell is subjected to a detection procedure.

126. A method according to claim 125, wherein the detection procedure comprises scanning the transmitter unit positions by means of a CCD camera or a fluorescence microscope.

127. A method for plasma analysis incorporating a microfluidic cell according to claim 52 comprising the steps of:
loading the cell by bringing active material to predetermined positions in the cell;
collecting plasma;
bringing an analytical flow containing the plasma through the cell;
letting the analytical flow interact with the active material;
performing a detection procedure scanning the different positions in the cell.

128. A method for plasma analysis incorporating a microfluidic cell according to claim 56 comprising the steps of:
loading the cell by bringing active material to predetermined positions in the cell;
collecting plasma;
bringing an analytical flow containing the plasma through the cell;
letting the analytical flow interact with the active material;
performing a detection procedure scanning the different positions in the cell.

129. A method for plasma analysis incorporating a microfluidic cell according to claim 70 comprising the steps of:
loading the cell by bringing active material to predetermined positions in the cell;
collecting plasma;
bringing an analytical flow containing the plasma through the cell;
letting the analytical flow interact with the active material;
performing a detection procedure scanning the different positions in the cell.
